(19) United States
(12) Patent Application Publication
(10) Pub. No.: US 2018/0285792 A1
(43) Pub. Date: Oct. 4, 2018

(54) METHOD AND SYSTEM FOR PROVIDING TRANSPORTATION SERVICE

(71) Applicant: BEIJING DIDI INFINITY TECHNOLOGY AND DEVELOPMENT CO., LTD., Beijing (CN)

(72) Inventors: Niping ZHANG, Beijing (CN); Lu LI, Beijing (CN); Zhan WANG, Beijing (CN); Kehua SHENG, Beijing (CN); Zhenghua WU, Beijing (CN)

(73) Assignee: BEIJING DIDI INFINITY TECHNOLOGY AND DEVELOPMENT CO., LTD., Beijing (CN)

(21) Appl. No.: 15/838,194

(22) Filed: Dec. 11, 2017

(30) Foreign Application Priority Data
Mar. 29, 2017 (CN) 201710195830.8

(51) Int. Cl. G06Q 10/06

(52) U.S. Cl. CPC G06Q 10/0631; G06Q 2240/00

(57) ABSTRACT

Methods and systems for providing transportation service are provided. The method can include receiving, from a remote passenger terminal, a transportation service request in an area. The method can further include detecting a first queue and a second queue associated with transportation services in the area. A first estimated wait time for the transportation service request to be processed in the first queue may be shorter than a second estimated wait time for the transportation service request to be processed in the second queue. The method can also include providing, to the remote passenger terminal, an option for the transportation service request to be placed in the first queue or the second queue, and placing the transportation service request in the first queue or the second queue in response to a user selection received from the remote passenger terminal.

### CROSS REFERENCE TO RELATED APPLICATION

The present application is based on and claims the benefits of priority to Chinese Application No. 201710195830.8, filed Mar. 29, 2017, the entire contents of which are incorporated herein by reference.

### TECHNICAL FIELD

The present disclosure relates to providing transportation service, and more particularly to, methods and systems for queuing a transportation service request.

### BACKGROUND

An online hailing platform (e.g., DiDi™ online) can receive a transportation service request from a passenger and then route the service request to at least one transportation service provider (e.g., a taxi driver, a private car owner, or the like). Generally, requests should be processed on a first in first out (FIFO) basis, i.e., an earlier request should be processed first. Exception may be made to urgent requests related to medical necessity or compelling business reasons. Such requests may be processed out of order. Sometimes, an extra fee (e.g., tips to the driver) may be required in order for the request to be prioritized. However, prioritizing requests based on extra service fee may affect the user experience of other passengers whose requests are still processed using FIFO.

Embodiments of the disclosure address the above problem by methods and systems for providing transportation service, which queue a transportation service request and improve the efficiency of the online hailing platform.

### SUMMARY

Embodiments of the disclosure provide a method for providing transportation service. The method can include receiving, from a remote passenger terminal, a transportation service request in an area. The method can further include detecting a first queue and a second queue associated with transportation services in the area. A first estimated wait time for the transportation service request to be processed in the first queue may be shorter than a second estimated wait time for the transportation service request to be processed in the second queue. The method can also include providing, to the remote passenger terminal, an option for the transportation service request to be placed in the first queue or the second queue, and placing the transportation service request in the first queue or the second queue in response to a user selection received from the remote passenger terminal.

Embodiments of the disclosure provide a system for providing transportation service. The system can include a communication interface configured to receive, from a remote passenger terminal, a transportation service request in an area, and a memory. The system can further include at least one processor coupled to the communication interface and the memory. The at least one processor can be configured to detect a first queue and a second queue associated with transportation services in the area. A first estimated wait time for the transportation service request to be processed in the first queue may be shorter than a second estimated wait time for the transportation service request to be processed in the second queue. The at least one processor can be further configured to provide, to the remote passenger terminal, an option for the transportation service request to be placed in the first queue or the second queue. The at least one processor can be also configured to place the transportation service request in the first queue or the second queue in response to a user selection received from the remote passenger terminal.

Embodiments of the disclosure provide a non-transitory computer-readable medium that stores a set of instructions. When the set of instructions are executed by at least one processor of an electronic device, the set of instructions cause the electronic device to perform a method for providing transportation service. The method can include receiving, from a remote passenger terminal, a transportation service request in an area. The method can further include detecting a first queue and a second queue associated with transportation services in the area. A first estimated wait time for the transportation service request to be processed in the first queue may be shorter than a second estimated wait time for the transportation service request to be processed in the second queue. The method can also include providing, to the remote passenger terminal, an option for the transportation service request to be placed in the first queue or the second queue, and placing the transportation service request in the first queue or the second queue in response to a user selection received from the remote passenger terminal.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of a system for providing transportation service, according to embodiments of the disclosure.

FIG. 2 illustrates a schematic diagram of transportation service requests and vehicles within an area, according to embodiments of the disclosure.

FIG. 3 illustrates an exemplary first queue and an exemplary second queue, according to embodiments of the disclosure.

FIG. 4A illustrates a first exemplary user interface displayed on a terminal, according to embodiments of the disclosure.

FIG. 4B illustrates a second exemplary user interface displayed on a terminal, according to embodiments of the disclosure.

FIG. 4C illustrates a third exemplary user interface displayed on a terminal, according to embodiments of the disclosure.

FIG. 4D illustrates a fourth exemplary user interface displayed on a terminal, according to embodiments of the disclosure.

FIG. 5 illustrates a flowchart of an exemplary method for providing transportation service, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a system for providing transportation service.

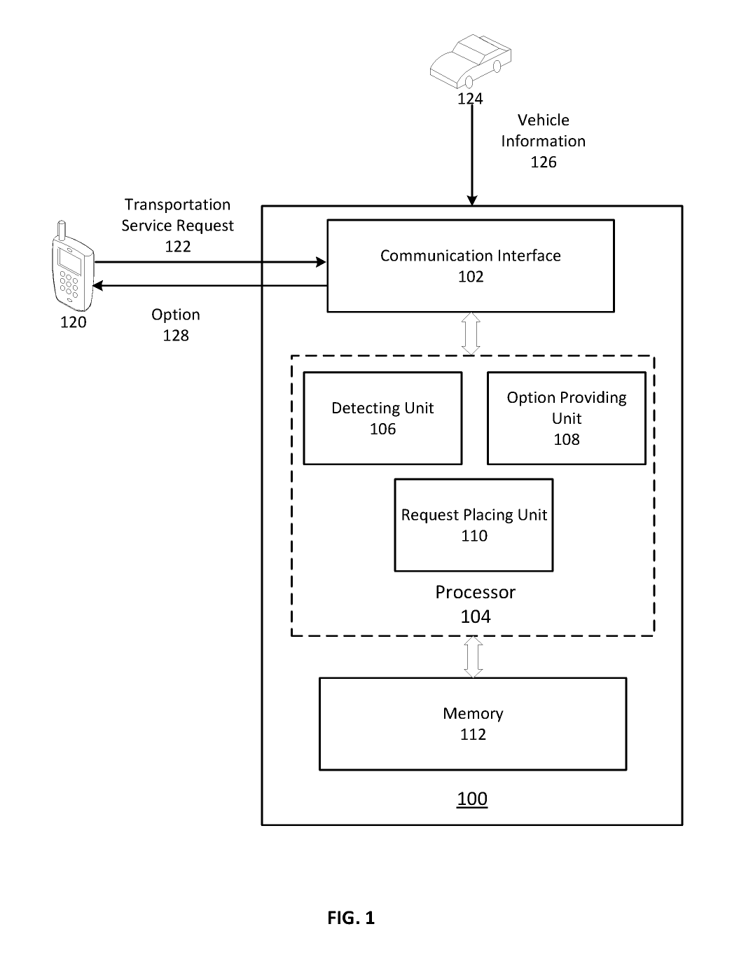

FIG. 1 illustrates a schematic diagram of a system 100 for providing transportation service, according to embodiments of the disclosure.

System 100 can be a general-purpose server or a proprietary device specially designed for providing transportation service. It is contemplated that, system 100 can be a separate system (e.g., a server) or an integrated component of a server. Because processing transportation service requests may require significant computation resources, in some embodiments, system 100 may be preferably implemented as a separate system. In some embodiments, system 100 may include sub-systems, some of which may be remote.

In some embodiments, as shown in FIG. 1, system 100 may include a communication interface 102, a processor 104, and a memory 112. Processor 104 may further include multiple modules, such as a detecting unit 106, an option providing unit 108, a request placing unit 110, and the like. These modules (and any corresponding sub-modules or sub-units) can be hardware units (e.g., portions of an integrated circuit) of processor 104 designed for use with other components or to execute a part of a program. The program may be stored on a computer-readable medium, and when executed by processor 104, it may perform one or more methods. Although FIG. 1 shows units 106-110 all within one processor 104, it is contemplated that these units may be distributed among multiple processors located near or remotely with each other. In some embodiments, system 100 may be implemented in the cloud, or on a separate computer/server.

Communication interface 102 may be configured to receive, from a remote passenger terminal 120, a transportation service request 122 in an area. Remote passenger terminal 120 can be any suitable device that can interact with a user, e.g., a smart phone, a tablet, a wearable device, a computer, or the like. Remote passenger terminal 120 may be a mobile device that can be carried by the user. Transportation service request 122 can include a current location of the passenger, an origin and a destination of the requested transportation, a request time, or the like. Generally, the origin of the requested transportation can be substantially close to a location of the remote passenger terminal. For example, remote passenger terminal 120 may detect its own location and automatically assign that location as the origin for the request. However, it is contemplated that, the origin of the requested transportation service can differ from the location of the remote passenger terminal. For example, a user can request a transportation service from a computer for his/her friend, who is distant from this user. As another example, the user may reserve a transportation service to originate from a location he is moving towards. Vehicle information 126 of service vehicles 124 can also be received by communication interface 102. Service vehicles 124 can include taxi cars and private cars which have been connected to the online hailing platform. It is contemplated that, service vehicles 124 can also be autonomous vehicles. Vehicle information 126 can include at least one of locations, capacities, current driving directions, vehicle models, or other features of the service vehicles.

Transportation service request 122 can be associated with a plurality of features (or otherwise known as “request parameters”), such as a price feature, a type feature, an area feature, and the like. These features characterize the requested transportation service. In some embodiments, the price feature can be generated based on transportation service request 122, and indicate a price that the passenger needs to pay for the transportation service. The area feature can indicate an area within which the transportation service request can be broadcast, or stated in another way, the area from which service vehicles will be dispatched to fulfil the transportation service request. The type feature can be included in transportation service request 122, and indicate a type of the transportation service, including a non-car-pooling type, a car-pooling type, and the like.

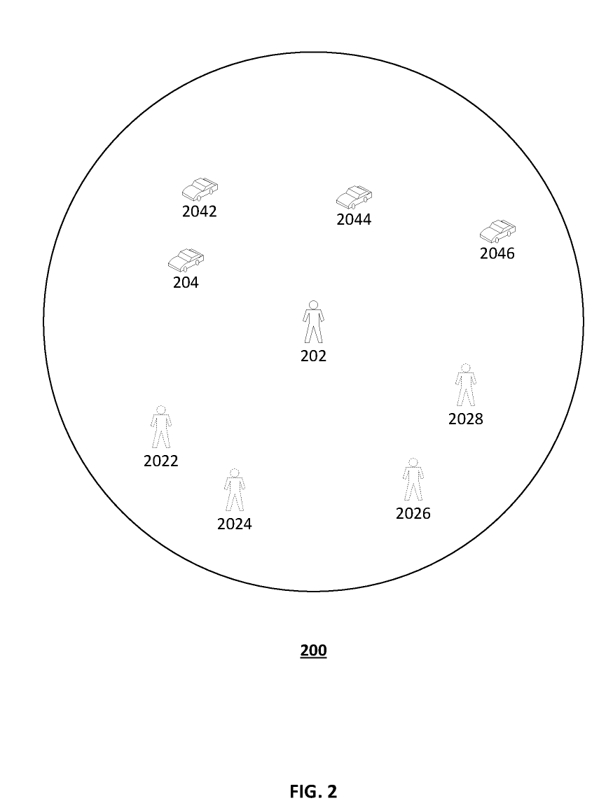

In some embodiments, the area can be a predetermined area that is set by system 100. For example, the area can be a hexagonal area that is neighbored with other hexagonal areas. It is contemplated that, the area can contain shapes other than a hexagon, such as a circle, a square, a rectangle, etc. In some embodiments, the area can be an area of shape and size dynamically determined based on the current location of remote passenger terminal 120. FIG. 2 illustrates a schematic diagram of transportation service requests and vehicles within an area 200, according to embodiments of the disclosure. As shown in FIG. 2, area 200 is a circular area that centered at the current location of a transportation service request 202. Transportation service requests 2022, 2024, 2026, and 2028 within area 200 also have requested transportation service but have not assigned a vehicle yet. Communication interface 102 of system 100 further receives vehicle information of service vehicles 204, 2042, 2044, and 2046, which are operating in area 200.

In some embodiments, communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network. The network can typically include a cellular communication network, a Wireless Local Area Network (WLAN), a Wide Area Network (WAN), or the like.

Detecting unit 106 can be configured to detect a first queue and a second queue associated with transportation services in the area, wherein a first estimated wait time for the transportation service request to be processed in the first queue is shorter than a second estimated wait time for the transportation service request to be processed in the second queue. Before the detection, detecting unit 106 may further determine whether the request needs to queued given the circumstances. In some embodiments, when the vehicles in area 200 can provide enough capacities to passengers, the transportation service requests do not have to be queued. In some embodiments, detecting unit 106 may first queue transportation service request 122 when the number of transportation service requests exceeds the capacity provided by the service vehicles by a predetermined value, or when the transportation service request is made within a predetermined time range. For example, the predetermined time range can be rush hours (e.g., 8:00-9:00 AM and 5:00-7:00 PM).

In some embodiments, a queue mode of the first queue can be “strict.” In a “strict” queue mode, transportation service requests are queued according to respective orders that the transportation service requests are received. The request time may be logged to determine the order. For example, in the first queue, a first request having a first request time is queued before a second request having a second request time which is later than the first request time, and accordingly, the first request will be assigned with a service vehicle earlier than the second request. That is, in a queue of the “strict” queue mode (e.g., the first queue), requests in the queue are answered strictly according to the request time. A queue mode of the second queue can be “non-strict.” In a “non-strict” queue mode (e.g., the second queue), instead of strictly by the request time, a priority of a request can be determined based on a collection of information associated with the requested transportation service, including, a request time, an origin, a destination, a length, an extra fee or the like. Transportation service requests are then queued based on the respective priorities. That is, in the non-strict queue mode, the requests are answered not strictly based on request time, but based on the totality of several factors.

In some embodiments, more than one queue may exist in area 200. For example, one queue may be a “strict” queue and another queue is a “non-strict” queue. As another example, different queues might be provided to different types of requests, e.g., a non-carpooling queue and a carpooling queue, or a queue for regularly-priced services and another queue for services with extra fees. Because the queuing mechanisms may be different, in some embodiments, the queues may have different lengths and therefore associated with different estimated wait time for any new request that is to be added to the end of the respective queues. Detecting unit 106 may be configured to detect these different queues associated with transportation services in area 200. For example, detecting unit 106 may detect a first queue and a second queue that has an estimated wait time shorter than that of the first queue.

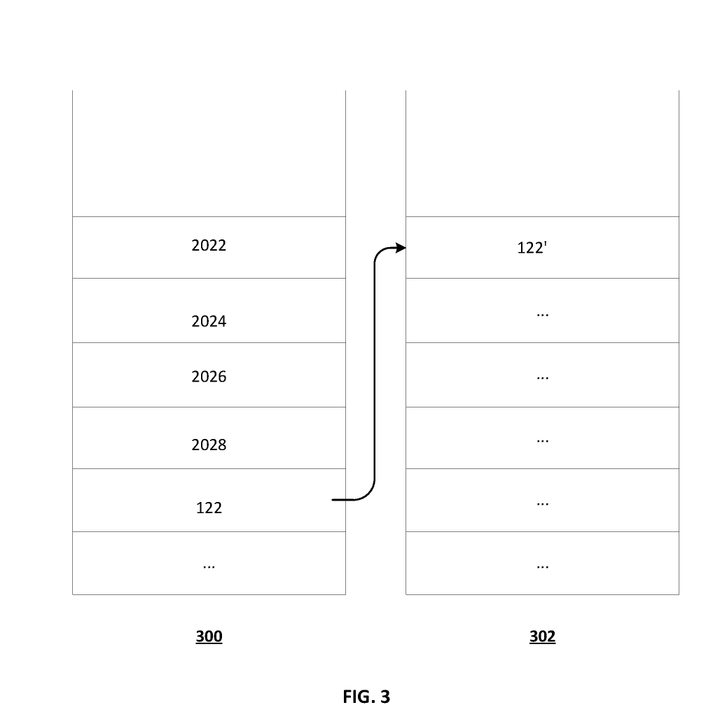

FIG. 3 illustrates an exemplary first queue 300 and an exemplary second queue 302, according to embodiments of the disclosure. First queue 300 is a “strict” queue, and second queue 302 is a “non-strict” queue. In “strict” first queue 300, transportation service requests 2022, 2024, 2028, and 202 are lined up, with transportation service request 2022 first in queue 300. When transportation service request 2022 is assigned to a vehicle, transportation service request 2024 becomes the next one to be assigned. In “non-strict” second queue 302, the order of the transportation service requests is determined according to the respective priorities. Therefore, when a transportation service request having a higher priority is placed to queue 302, the transportation service request may be assigned to a vehicle out of order. With the existence of queues 300 and 302, in some embodiments, the passenger may be offered a choice to be placed in one of the two queues.

With reference back to FIG. 1, option providing unit 108 can be configured to provide, to remote passenger terminal 120, an option 128 for transportation service request 122 to be placed in first queue 300 or second queue 302. A passenger can select to accept or refuse option 128 on remote passenger terminal 120.

Option providing unit 108 can be configured to provide option 128 to remote passenger terminal 120 under a predetermined condition. In some embodiments, the predetermined condition may be that at least one of a number of service vehicles operating in area 200 is less than a number of transportation service requests in area 200 by a predetermined number. Alternatively or additionally, the condition may be that transportation service request 122 is made within a predetermined time range.

When area 200 has transportation service requests more than available service vehicles by the predetermined number, option providing unit 108 may send out option 128 to remote passenger terminal 120. In some embodiments, the predetermined number can be a fixed number or determined according to area 200. For example, the predetermined number can be proportional to the area of area 200.

Option 128 provides suggestions to the passenger to modify his request, in order for the request to be placed in a queue with shorter wait time. The passenger may confirm on remote passenger terminal 120 whether to accept modifications to transportation service request 122. Depending on the passenger's choice, transportation service request 122 will be placed in first queue 300 or second queue 302. Similarly, when transportation service request 122 is made within a predetermined time range (e.g., rush hours of 7:00 AM-9:30 AM and 5:30 PM-8:00 PM), the passenger may also be offered the option to place transportation service request 122 in first queue 300 or second queue 302.

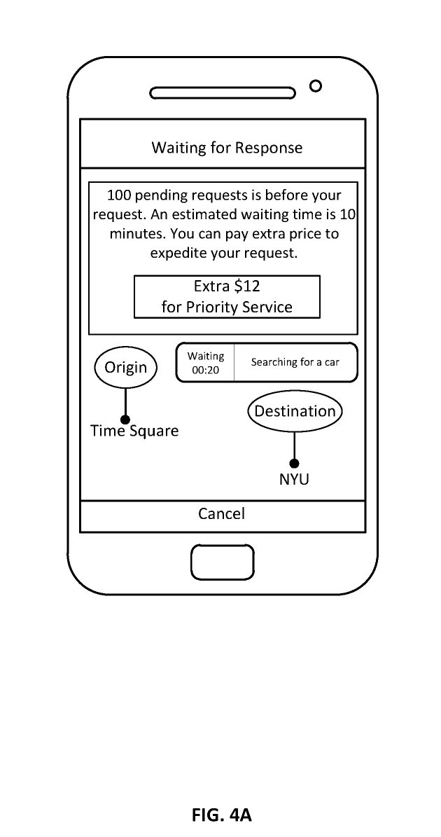

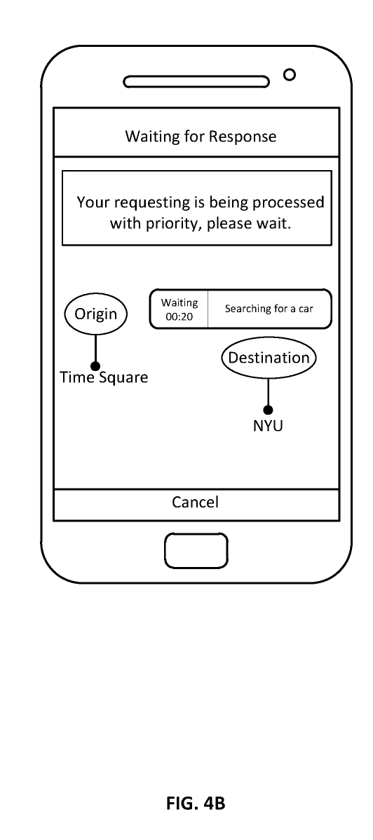

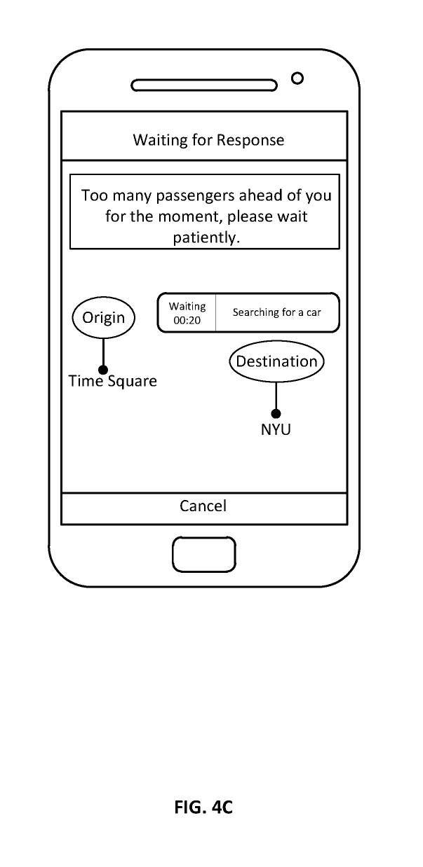

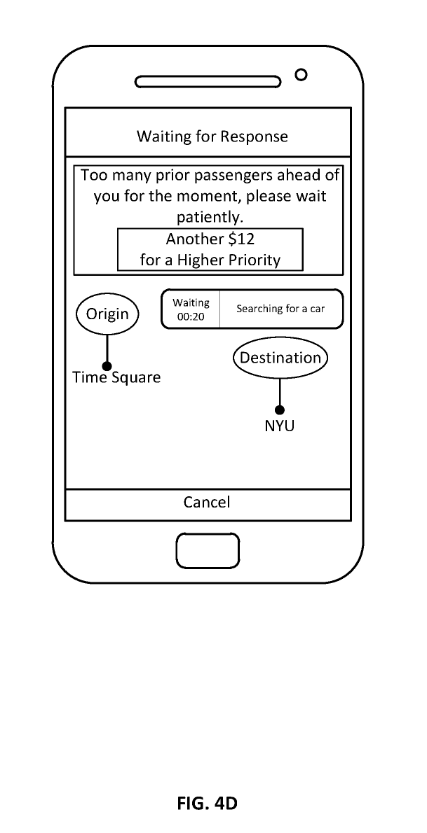

FIG. 4A illustrates a first exemplary user interface displayed on a terminal, according to embodiments of the disclosure. As shown in FIG. 4A, the user interface of remote passenger terminal 120 can display option 128, which is to pay “Extra $12 for priority service.” When the passenger accepts option 128, option providing unit 108 can modify the price feature of transportation service request 122, and place modified transportation service request 122′ in second queue 302. When the passenger refuses option 128, option providing unit 108 can place original transportation service request 122 in first queue 300. That is, transportation service request 122 in first queue 300 has a first estimated price. By paying a second estimated price that is higher than the first estimated price, modified transportation service request 122′ may be placed in second queue 302, which has a shorter wait time.

In some embodiments, a difference between the first estimated price and the second estimated price can be a fixed number proposed by option 128, as shown in FIG. 4A. In some embodiments, the difference between the first estimated price and the second estimated price may be specified by the passenger. In some embodiments, the difference can be dynamically determined in association with transportation service request 122. For example, the difference can be determined based on the origin, the destination, a requesting time associated with transportation service request 122. If the origin and/or the destination is a unpopular location, the difference between the first and second estimated prices can be set large. If the distance is long, the difference between the first and second estimated prices can be increased accordingly.

It is contemplated that, option 128 can further indicate other changes to transportation service request 122, including dispatching a service vehicle from a remote area or changing a non-car-pooling request to a car-pooling request.

For example, the type feature of transportation service request 122 can be a non-car-pooling type, and option 128 may suggest the passenger to modify the type feature of transportation service request 122 to a car-pooling type. Therefore, the passenger who is willing to accept the proposed option 128 can share a ride with other passenger(s) using car-pooling, and the request of this passenger can be fulfilled with a priority.

In another example, the area feature of transportation service request 122 indicates whether service vehicles are dispatched from within area 200 or from outside area 200. When service vehicles cannot provide enough capacities in area 200, other areas may still have available vehicles. With the change of the area feature, the passenger can request a service vehicle in another area to pick him up. In some embodiments, the passenger may be asked to compensate the service vehicle for the drive from the remote area, and thus the modified service request may be at a higher cost.

Request placing unit 110 can be configured to place the transportation service request in the first queue or the second queue in response to a user selection received from remote passenger terminal 120.

In some embodiments, request placing unit 110 can be further configured to determine a priority of transportation service request 122 based on at least one of the price feature, the type feature, and the area feature of transportation service request 122.

With reference back to FIG. 3, upon the user selection of accepting option 128, a priority of transportation service request 122 can be determined. Request placing unit 110 can determine a position of transportation service request 122 in second queue 302 based on the priority, and place transportation service request 122 to second queue 302 accordingly. Modified transportation service request 122′, for example, includes a higher price for the trip (e.g., extra $12), accepts the car-pooling and a service vehicle dispatched from outside area 200, and thus can have a priority that ranks on top of queue 302.

In some embodiments, a first ratio of a number of service vehicles assigned to queue 300 to a number of transportation service requests waiting in queue 300 is less than a second ratio of a number of service vehicles assigned to queue 302 to a number of transportation service requests waiting in queue 302. Therefore, transportation service requests waiting in queue 302 (e.g., transportation service request 122′) may be fulfilled more quickly. It is contemplated that, a minimum value of the first ratio can be preset, so that the user experience of transportation service requests in queue 300 may not be over deteriorated.

It is contemplated that, while transportation service request 122′ is waiting in queue 302, transportation service request 122 can remain active and waiting in queue 300. That way, the transportation service request may be fulfilled no later than the waiting in one queue.

FIG. 4B illustrates a second exemplary user interface displayed on a terminal, according to embodiments of the disclosure. As shown in FIG. 4B, after the passenger confirms option 128 and accepts the modification, the user interface of remote passenger terminal 120 can display information with “Your requesting is being processed with priority, please wait.” FIG. 4C illustrates a third exemplary user interface displayed on a terminal, according to embodiments of the disclosure. If queue 302 contains too many requests, as shown in FIG. 4C, the user interface of remote passenger terminal 120 can display information with “Too many passengers ahead of you for the moment, please wait patiently.” FIG. 4D illustrates a fourth exemplary user interface displayed on a terminal, according to embodiments of the disclosure. When too many requests are waiting in queue 302, system 100 can further generate an option of paying even a higher price in exchange for a higher priority. As shown in FIG. 4D, an option of “Another $12 for a Higher Priority” can be provided.

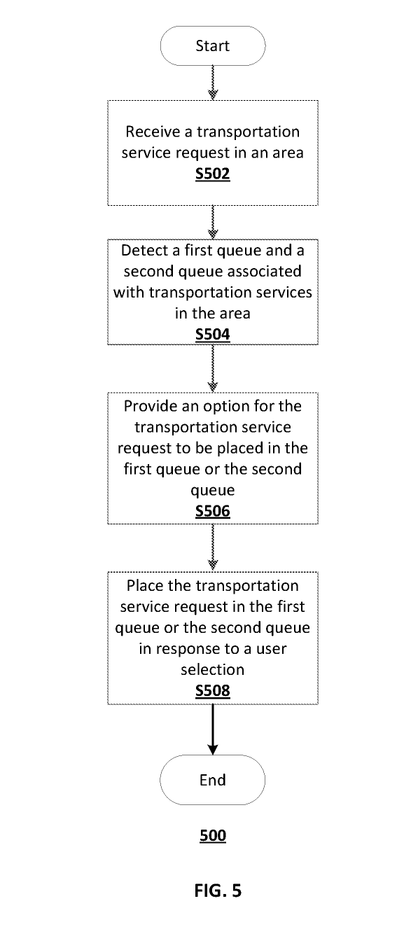

Another aspect of the disclosure is directed to a method for providing transportation service. FIG. 5 illustrates a flowchart of a method 500 for providing transportation service, according to embodiments of the disclosure. For example, method 500 may be implemented by system 100 including at least one processor, and method 500 may include steps S502-S508 as described below.

In step S502, system 100 can receive, from a remote passenger terminal, a transportation service request in an area. The transportation service request can include a current location of the passenger, an origin and a destination of the requested transportation, a request time, or the like. Generally, the origin of the requested transportation can be substantially close to a location of the remote passenger terminal. However, it is contemplated that, the origin of the requested transportation service can differ from the location of the remote passenger terminal, even if the transportation service request is sent from the terminal. System 100 can also receive vehicle information including at least one of locations, capacities, current driving directions, vehicle models, or other features of the service vehicles.

Transportation service request can be associated with a plurality of features (or otherwise known as “request parameters”), such as a price feature, a type feature, an area feature, and the like. These features characterize the requested transportation service. In some embodiments, the price feature can be generated based on the transportation service request, and indicate a price that the passenger needs to pay for the transportation service. The area feature can indicate an area within which the transportation service request can be broadcast, or stated in another way, the area from which service vehicles will be dispatched to fulfill the transportation service request. The type feature can be included in the transportation service request, and indicate a type of the transportation service, including a non-car-pooling type, a car-pooling type, and the like.

In some embodiments, the area can be a predetermined area that is set by system 100. For example, the area can be a hexagonal area that is neighbored with other hexagonal areas. It is contemplated that, the area can contain shapes other than a hexagon, such as a circle, a square, a rectangle, etc. In some embodiments, the area can be an area of shape and size dynamically determined based on the current location of the remote passenger terminal.

In step S504, system 100 can detect a first queue and a second queue associated with transportation services in the area, wherein a first estimated wait time for the transportation service request to be processed in the first queue is shorter than a second estimated wait time for the transportation service request to be processed in the second queue. In some embodiments, method 500 can further include determining whether the transportation service request needs to be queued given the circumstances.

In some embodiments, a queue mode of the first queue can be “strict.” In a “strict” queue mode, transportation service requests are queued according to respective orders that the transportation service requests are received. A queue mode of the second queue can be “non-strict.” In a “non-strict” queue mode (e.g., the second queue), instead of strictly by the request time, a priority of a request can be determined based on a collection of information associated with the requested transportation service, including, a request time, an origin, a destination, a length, an extra fee or the like. Transportation service requests are then queued based on the respective priorities.

It is contemplated that, in some embodiments, more than one queue may exist in the area. For example, one queue may be a “strict” queue and another queue is a “non-strict” queue. As another example, different queues might be provided to different types of requests, e.g., a non-carpooling queue and a carpooling queue, or a queue for regularly-priced services and another queue for services with extra fees. Because the queuing mechanisms may be different, in some embodiments, the queues may have different lengths and therefore associated with different estimated wait time for any new request that is to be added to the end of the respective queues. These different queues associated with transportation services in the area can be detected in step S504. For example, a first queue and a second queue that has an estimated wait time shorter than that of the first queue can be detected.

In step S506, system 100 can provide, to the remote passenger terminal, an option for the transportation service request to be placed in the first queue or the second queue. A passenger can select to accept or refuse the option on the remote passenger terminal.

System 100 can provide the option to the remote passenger terminal under a predetermined condition. The predetermined condition may be that at least one of a number of service vehicles operating in the area is less than a number of transportation service requests in area by a predetermined number. Alternatively or additionally, the condition may be that the transportation service request is made within a predetermined time range.

In some embodiments, the predetermined number can be a fixed number proposed by the option.

The transportation service request in the first queue can have a first estimated price, the corresponding modified transportation service request in the second queue can have a second estimated price that is higher than the first estimated price. That is, system 100 can modify the price feature of the transportation service request to increase a service price. A difference between the first estimated price and the second estimated price can be a fixed amount, or specified by the passenger. For example, the service price is increased by a fixed amount. In some embodiments, the difference can be determined in association with the transportation service request. For example, the difference can be determined based on the origin, the destination, a request time associated with the transportation service request.

It is contemplated that, the option can further indicate other changes to the transportation service request, including dispatching a service vehicle from a remote area or changing a non-car-pooling request to a car-pooling request.

For example, the type feature of the transportation service request can be a non-car-pooling type, and the option may suggest the passenger to modify the type feature of the transportation service request to a car-pooling type. Therefore, the passenger who is willing to accept the proposed option can share a ride with other passenger(s) using car-pooling.

In another example, the area feature of the transportation service request can be modified to dispatch service vehicles from outside the area. With the change of the area feature, the passenger can request a service vehicle in another area to pick him up. In some embodiments, the passenger may be asked to compensate the service vehicle for the drive from the remote area, and thus the modified request may be at a higher cost.

In step S508, system 100 can be place the transportation service request in the first queue or the second queue in response to a user selection received from the remote passenger terminal.

In some embodiments, system 100 can determine a priority of the transportation service request based on at least one of the price feature, the type feature, and the area feature of the transportation service request.

Upon the user selection of accepting the option, a priority of the transportation service request 122 be determined. System 100 can further determine a position of the transportation service request in the second queue based on the priority, and place the transportation service request to the second queue accordingly.

In some embodiments, a first ratio of a number of service vehicles assigned to the first queue to a number of transportation service requests waiting in the first queue is less than a second ratio of a number of service vehicles assigned to the second queue to a number of transportation service requests waiting in the second queue. Therefore, transportation service requests waiting in the first queue can be fulfilled more quickly. It is contemplated that, a minimum value of the first ratio can be preset, so that the user experience of transportation service requests in the first queue may not be over deteriorated.

It is contemplated that, while transportation service request in the second queue is pending, the corresponding transportation service request in the first queue can remain active and waiting in the first queue.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
receiving, from a remote passenger terminal, a transportation service request in an area;
detecting a first queue and a second queue associated with transportation services in the area, wherein a first estimated wait time for the transportation service request to be processed in the first queue is shorter than a second estimated wait time for the transportation service request to be processed in the second queue;
providing, to the remote passenger terminal, an option for the transportation service request to be placed in the first queue or the second queue; and
placing the transportation service request in the first queue or the second queue in response to a user selection received from the remote passenger terminal.

2. The method of claim 1, wherein the transportation service request is associated with a price feature, a type feature, and an area feature.

3. The method of claim 2, further comprising modifying the price feature of the transportation service request to increase a service price.

4. The method of claim 3, wherein the service price is increased by a fixed amount.

5. The method of claim 2, further comprising modifying the type feature of the transportation service request to a car-pooling type.

6. The method of claim 2, further comprising modifying the area feature of the transportation service request to dispatch service vehicles from outside the area.

7. The method of claim 2, further comprising:
determining a priority of the transportation service request based on at least one of the price feature, the type feature, and the area feature of the transportation service request.

8. The method of claim 7, wherein
a position of the transportation service request in the second queue is determined based on the priority.

9. The method of claim 1, further comprising:
providing the option for the transportation service request to be placed in the first queue or the second queue under a predetermined condition, wherein the predetermined condition includes at least one of a number of service vehicles operating in the area being less than a number of transportation service requests in the area by a predetermined number, and a request time of the transportation service request being made within a predetermined time range.

10. The method of claim 1, wherein a first ratio of a number service vehicles assigned to the first queue to a number of transportation service requests waiting in the first queue is less than a second ratio of a number of service vehicles assigned to the second queue to a number of transportation service requests waiting in the second queue, and the first ratio is equal to or greater than a predetermined value.

11. A system for providing transportation service, comprising:
a communication interface configured to receive, from a remote passenger terminal, a transportation service request in an area;
a memory; and
at least one processor coupled to the communication interface and the memory, configured to:
detect a first queue and a second queue associated with transportation services in the area, wherein a first estimated wait time for the transportation service request to be processed in the first queue is shorter than a second estimated wait time for the transportation service request to be processed in the second queue;
provide, to the remote passenger terminal, an option for the transportation service request to be placed in the first queue or the second queue; and
place the transportation service request in the first queue or the second queue in response to a user selection received from the remote passenger terminal.

12. The system of claim 11, wherein the transportation service request is associated with a price feature, a type feature, and an area feature.

13. The system of claim 12, wherein the at least one processor is further configured to modify the price feature of the transportation service request to increase a service price.

14. The system of claim 13, wherein the service price is increased by a fixed amount.

15. The system of claim 12, wherein the at least one processor is further configured to modify the type feature of the transportation service request to a car-pooling type.

16. The system of claim 12, wherein the at least one processor is further configured to modify the area feature of the transportation service request to dispatch service vehicles from outside the area.

17. The system of claim 12, wherein the at least one processor is further configured to:
determine a priority of the transportation service request based on at least one of the price feature, the type feature, and the area feature of the transportation service request.

18. The system of claim 17, wherein
a position of the transportation service request in the second queue is determined based on the priority.

19. The system of claim 11, wherein a first ratio of a number service vehicles assigned to the first queue to a number of transportation service requests waiting in the first queue is less than a second ratio of a number of service vehicles assigned to the second queue to a number of transportation service requests waiting in the second queue, and the first ratio is equal to or greater than a predetermined value.

20. A non-transitory computer-readable medium that stores a set of instructions, when executed by at least one processor of an electronic device, cause the electronic device to perform a method for providing transportation service, the method comprising:
receiving, from a remote passenger terminal, a transportation service request in an area;
detecting a first queue and a second queue associated with transportation services in the area, wherein a first estimated wait time for the transportation service request to be processed in the first queue is shorter than a second estimated wait time for the transportation service request to be processed in the second queue;
providing, to the remote passenger terminal, an option for the transportation service request to be placed in the first queue or the second queue; and
placing the transportation service request in the first queue or the second queue in response to a user selection received from the remote passenger terminal.
